(19) United States
(12) Patent Application Publication
(10) Pub. No.: US 2017/0012484 A1
(43) Pub. Date: Jan. 12, 2017

(54) STATOR STRUCTURE FOR A MOTOR UNIT

(71) Applicant: JENN FENG NEW ENERGY CO., LTD., Pingchang City (TW)

(72) Inventor: Cheng Chao JONG, Taoyuan City (TW)

(73) Assignee: JENN FENG NEW ENERGY CO., LTD., Pingchang City (TW)

(21) Appl. No.: 14/929,656

(22) Filed: Nov. 2, 2015

(30) Foreign Application Priority Data
Jul. 8, 2015 (TW) 104122205

(51) Int. Cl. H02K 3/28; H02K 3/38

(52) U.S. Cl. CPC H02K 3/28; H02K 3/38

(57) ABSTRACT

A stator structure for an electric motor unit, includes a main body; an insulated member mounted on the main body; a plastic body disposed on the insulated member; a copper circuit path disposed on the plastic body; a plurality of first and second windings, each being wound on the main body, consisting of a metal wire and a coated sheath enclosing the metal wire and includes first and second leading ends extending through the insulated member so as to be soldered on the copper circuit path; and several power conducting wires, each having a distal section soldered with the corresponding second leading end of a respective one of the second windings.

### BACKGROUND OF THE INVENTION

1. Field of the Invention

The present invention relates generally to a stator structure, and more particularly to a stator winding structure for an electrical motor unit.

2. The Prior Arts

In a conventional electrical motor unit, each of the windings is wound properly around a silicone-steel main body, after which leading ends of a plurality of stator windings are pulled out and coupled sequentially in such a manner to form three independent winding units, after which two leading ends of each winding units are coupled respectively with the other leading ends of the winding units by means of connection wire so as to define 3-phase Y-shaped or Δ-shaped configuration power system. In order to ensure insulation between an adjacent pair of the connection wires and between one connection wire and a respective winding unit, insulated sheaths should be sleeved over the connection wires. Finally, the leading heads of three phase winding units are guided outward for soldering with a printed circuit board. Each winding implemented in the traditional stator structure generally includes a metal wire and a coated sheath sleeved around the metal wire in order to protect the same.

It is noted that during and for the soldering process of the windings of the stator relative to the printed circuit board, a portion of the coated sheath needs to be removed manually in order to expose the leading end of the metal wire from the coated sheath then only the leading end can be soldered on the soldering spot of the printed circuit board. It is laborious and time-wasting to remove a portion of the coated sheath for exposing the leading end prior to the soldering process.

Moreover, the copper wires of the traditional stator structure are fixed on the soldering spots of the printed circuit board via iron soldering process. It is noted that iron soldering process causes lots of manual labor and time-wasting.

In addition, for precisely and securely soldering the windings on the soldering spots of the printed circuit board, manual labor is required for treating the plurality of windings and hence is laborious.

### SUMMARY OF THE INVENTION

A primary objective of the present invention is to provide a stator structure for an electric motor unit, in which a plastic member encloses a copper circuit path, after which first and second leading ends of first and second windings are soldered on the copper circuit path without needing manual labor, thereby economizing the labor waste and time-wasting.

Another objective of the present invention is to provide a stator structure for an electric motor unit, in which first and second leading ends of first and second windings are spot-soldered on the copper circuit path, thereby eliminating the manual removal of portions of the coated sheaths for exposing the first and second leading ends and economizing the labor waste and time-wasting.

Yet another objective of the present invention is to provide a stator structure for an electric motor unit, in which distal sections of power conducting wires are spot-soldered on the second leading ends of the second windings without needing manual labor, thereby economizing the labor waste and time-wasting.

Still another objective of the present invention is to provide a stator structure for an electric motor unit, in which an automatic spot soldering device is implemented for the soldering process, thereby economizing the labor waste and time-wasting.

A stator structure of the present invention for an electric motor unit accordingly includes a main body, an insulated member, a plastic body, a copper circuit path, a plurality of first windings, a plurality of second windings and a plurality of power conducting wires.

The insulated member is mounted on the main body.

The plastic body is disposed on the insulated member.

The copper circuit path is disposed on the plastic body.

Each of the first windings is wound on the main body, consists of a first metal wire and a first coated sheath enclosing the first metal wire, and includes a first leading end extending through the insulated member so as to be soldered on the copper circuit path.

Each of the second windings is wound on the main body, consists of a second metal wire and a second coated sheath enclosing the second metal wire, and including a second leading end extending through the insulated member so as to be soldered on the copper circuit path.

Each of the power conducting wires has a distal section soldered with the corresponding second leading end of a respective one of the second windings.

In one embodiment of the present invention, the first and second leading ends of the first and second windings are spot-soldered respectively on the copper circuit path while the distal section of a respective one of the power conducting wires is spot-soldered to the second leading end of a respective one of the second windings. To be more specific, the first and second leading ends of the first and second windings are spot-soldered respectively on the copper circuit path by means of a spot-soldering device while the distal section of a respective one of the power conducting wires is soldered to the second leading end of a respective one of the second windings by means of the spot-soldering device.

According to one embodiment of the present invention, the plastic member is ring-shaped, and defines an annular recess in order to receive the copper circuit path therein. The first and second leading ends of the first and second windings extend into the annular recess for soldering with the copper circuit path. The plastic member preferably has an annular peripheral portion formed with a plurality of first notches in spatial communication with the annular recess such that the first and second leading ends of the first and second windings pass through the first notches for access into the annular recess so as to be soldered with the copper circuit path. More preferably, the annular recess is accessible from an upper side of the plastic member.

According to one embodiment of the present invention, the stator structure includes three first windings, three second windings and three power conducting wires. The copper circuit path preferably consists of a major curved section and three minor curved sections, each having a curved length shorter than that of the major curved section. The first leading ends of the three first windings are soldered on the major curved section while the second leading ends of the three second windings are soldered on the three minor curved sections respectively. The three distal sections of the three power conducting wires are soldered respectively on the second leading ends of the three second windings while the other three distal sections of the three power conducting wires are coupled electrically with a three-phase A/C electric power. To be more specific, the major curved section and three minor curved sections of the copper circuit path are formed by punching in such a manner that the major curved section and one minor curved section adjacent to the major curved section cooperatively define a gap therebetween and an adjacent pair of the minor curved sections define a gap therebetween. In other words, the major and minor curved sections cooperatively define 4 gaps. The plastic member is ring-shaped, and has an annular inner peripheral portion formed with four notches, which are aligned with the gaps formed between the major curved section and adjacent one minor curved section and the adjacent pair of the minor curved sections. The plastic member further defines four positioning holes located exterior of the annular peripheral portion and respectively aligned with corresponding ones of the gaps formed between the major curved section and adjacent one minor curved section and the adjacent pair of the minor curved sections.

One specific feature of the present invention resides in that no manual labor is required for removing portions of the coated sheaths for exposing the first and second leading ends of the first and second wings. No solder iron is required for soldering the first and second leading ends of the first and second windings on the copper circuit path, thereby economizing the labor waste and time-wasting.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a stator structure of the present invention for an electric motor unit;

FIG. 2 is a perspective and exploded view of the stator structure of the present invention for an electric motor unit; and

FIG. 3 is a fragmentary cross-sectional view of the stator structure of the present invention for an electric motor unit taken along Line A-A in FIG. 1.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

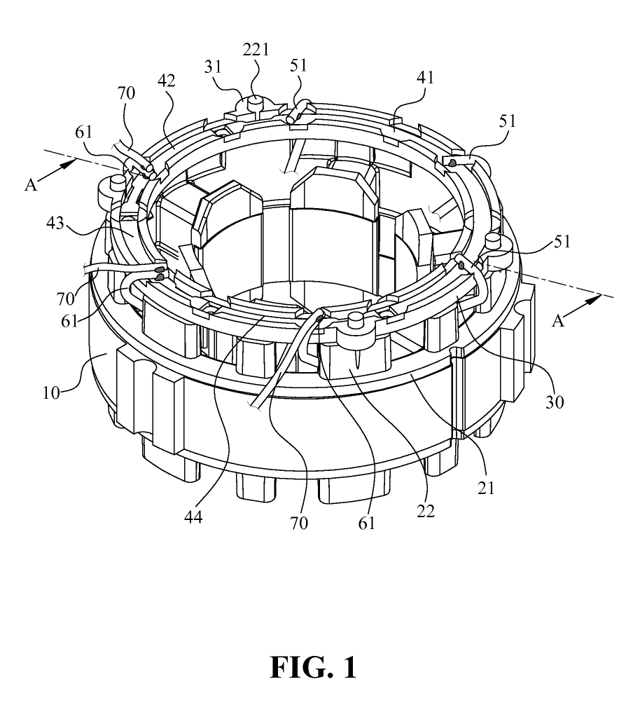

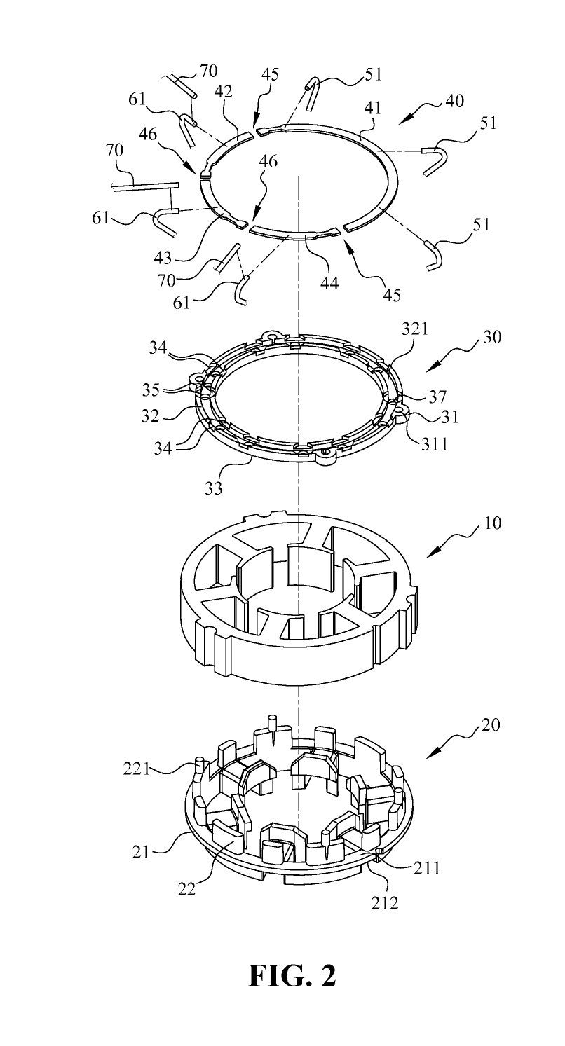

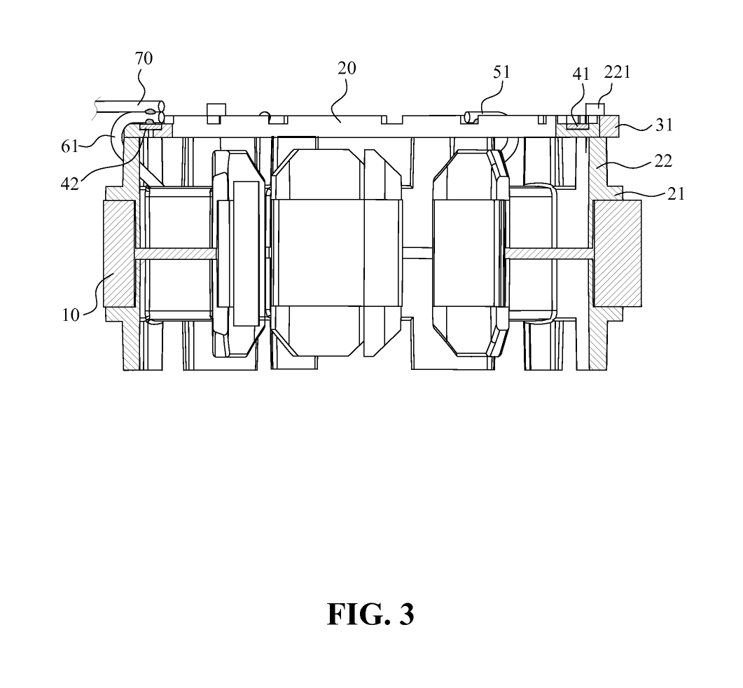

Referring to FIGS. 1-3, wherein FIG. 1 is a perspective view of a stator structure of the present invention for an electric motor unit; FIG. 2 is a perspective and exploded view of the stator structure of the present invention for an electric motor unit; and FIG. 3 is a fragmentary cross-sectional view of the stator structure of the present invention for an electric motor unit. A stator structure for an electric motor unit according to the present invention includes a main body 10, a ring-shaped insulated member 20, a ring-shaped plastic body 30, a copper circuit path 40, three first windings, three second windings and three power conductive wires 70.

The main body 10 is fabricated from silicon-steel materials, is cylindrical shaped, and has opposite upper and lower end portions.

The insulated member 20 includes an annular ring 21 having a lower end portion 212 mounted the upper end portion of the main body 10, an upper end portion 211, and a plurality of support blocks 22 that extend vertically from the upper end portion 211, that are angularly spaced relative to each other and each of which has an insert post 221 extending vertically from the respective one of the support blocks 22.

The plastic body 30 is ring-shaped, has a lower end portion 33 disposed on the upper end portion 211 of the insulated member 20. The plastic body 30 further has annular outer and inner peripheral portions and a plurality of lugs 31 projecting radially and outwardly from the outer peripheral portion and each is formed with a through hole 311 such that the insert posts 221 of the insulated member 20 extend therethrough so as to prevent untimely disengagement of the plastic body 30 from the insulated member 20. The upper end portion 32 of the plastic body 30 is formed with an annular recess 321 for receiving the copper circuit path 40 therein. The plastic body 30 further has a plurality pair of first and second notches 34, 35 formed respectively at the annular outer and inner peripheral portions such that the first and second notches 34, 35 are angularly spaced relative to each other in such a manner that each second notch 35 is located between an adjacent pair of the first notches 34. In other words, each first notch 34 is located between an adjacent pair of the second notches 35 and is in spatial communication with the annular recess 321. The annular recess 321 is accessible from an upper side of the plastic body 30. Note that one pair of second notches 35 cooperating with two adjacent pairs of the first notches 34 defines two distances different from each other such that each lug 31 is located between an adjacent pair of the first and second notches 34, 35 (see FIG. 2). In this embodiment, there are six pairs of the first and second notches 34, 35 formed respectively at the outer and inner peripheral portions of the plastic body 30, thereby defining twelve positioning channels 37, each extends in an axial direction of the plastic body 30 and each positioning channel 37 is in spatial communication with the annular recess 321.

The copper circuit path 40 is disposed in the annular recess 321 of the plastic body 30, has a circular configuration. To be more specific, the copper circuit path 40 consists of a major curved section 41 and three minor curved sections 42, 43, 44, each has a curved length shorter than that of the major curved section 41. Preferably, the major and minor curved sections 41, 42, 43 and 44 respectively have the same curvature with different curved lengths. In this embodiment, the major curved section 41 is semi-circular shaped while each of the minor curved sections 42, 43 and 44 has a ⅙ curved length of a circle. Preferably, the major curved section 41 and three minor curved sections 42, 43 and 44 of the copper circuit path 40 are formed by punching in such a manner that after the copper circuit path 40 is disposed in the annular recess 321, the major curved section 41 and one minor curved section adjacent to the major curved section 41 cooperatively define a gap 45 therebetween and an adjacent pair of the minor curved sections 42, 43 and 44 define another gap therebetween. Hence, the major and minor curved sections 41, 42, 43, 44 of the copper circuit path cooperatively define four gaps 45, 46 in the annular recess 321 such that the four gaps 45, 46 are respectively aligned with four positioning channels 37 defined by corresponding four pairs of the second notches 35. It is to note that at this time, two opposite ends of the major curved section 41 are not aligned with the correspond pair of the second notches 35 proximate to the two opposite ends. Formation of the major curved section 41 and the minor curved sections 42, 43, 44 of the copper circuit path 40 can be other means rather than only the punching operation, but should not be limited any one of them.

Each first winding is wound on the main body 10, consists of a first metal wire (preferably made from copper) and a first coated sheath enclosing the first metal wire , and includes a first leading end 51 extending through a gap between adjacent pair of the support blocks 22 in the insulated member 20 and wrapped around an exterior of the plastic body 30 so as to pass through the first notch 34 for access into the annular recess 321 for soldering with the major curved section 41 of the copper circuit path 40. To be more specific, an automatic spot soldering device is applied in the present invention for spot-soldering a lower surface of the first leading ends 51 of the first windings on the major curved section 41 (indicated by black spot in FIG. 1). Note that only the first leading ends 51 are shown in the drawing, while the first windings themselves are not visible and since mounting of the first windings on the main body 10 is known in the relevant art, detailed description thereof is omitted herein for the sake of brevity.

Each second winding is wound on the main body 10, consists of a second metal wire (preferably made from copper) and a second coated sheath enclosing the second metal wire, and includes a second leading end 61 extending through a gap between adjacent pair of the support blocks 22 in the insulated member 20 and wrapped around an exterior of the plastic body 30 so as to pass through the first notch 34 for access into the annular recess 321 for soldering with the minor curved sections 42, 43, 44 of the copper circuit path 40. To be more specific, an automatic spot soldering device is applied in the present invention for spot-soldering a lower surface of the second leading ends 61 of the second windings on the minor curved sections 42, 43, 44 (indicated by black spot in FIG. 1). Note that only the second leading ends 61 are shown in the drawing, while the second windings themselves are not visible and since mounting of the second windings on the main body 10 is known in the relevant art, detailed description thereof is omitted herein for the sake of brevity.

Each power conducting wire 70 has a distal section soldered with the corresponding second leading end 61 of a respective one of the second windings. Preferably, an automatic spot soldering device is applied in the present invention for spot-soldering a lower surface of the first distal sections of the power conducting wires 70 on the second leading ends 61 of the second windings (indicated by black spot in FIG. 1) while the second distal sections of the power conducting wires 70 are coupled electrically with a three-phase A/C power source (not visible). The three power conducting wires respectively are R, S, T conducting wires of the three-phase A/C power source.

It is to note that the technical feature of forming circuit paths in the printed circuit board is substituted by the plastic body 30 covering the copper circuit path 40 such that the lower surfaces of the first and second leading ends 51, 61 of the first and second windings can be directly soldered on the copper circuit path 40, thereby avoiding the problem of manually treating the windings and hence economizing the labor waste and time-wasting.

In addition, after the first and second leading ends 51, 61 of the first and second windings are wrapped around the exterior of the plastic body 30, they flatly pass through the first notches 34 so as to be soldered evenly on the major and minor curved sections 41, 42, 43, 44 of the copper circuit path 40. In this way, the contacting surface area between the first and second leading ends 51, 61 and the major and minor curved sections 41, 42, 43, 44 is increased, which, in turn, facilitates the soldering process between the first and second leading ends 51, 61 and the major and minor curved sections 41, 42, 43, 44.

Moreover, since the annular recess 321 is exposed from the upper end portion of the plastic body 30, it is relatively easy to place the copper circuit path 40 into the annular recess 321 while the distal sections of the power conducting wires 70 can be soldered directly onto the second leading ends 61 of the second windings without any hindrance. In other words, the automatic spot soldering process can be easily conducted due to little hindrance.

Since the gaps 45, 46 defined cooperatively by the major and minor curved sections 41, 42, 43, 44 are respectively aligned with the four positioning channels 37, placing of the copper circuit path 40 in the annular recess 321 can be conducted easily and precisely, thereby eliminating the undesired error caused from the placing.

Moreover, since the first leading ends 51 of the first windings are spot-soldered on the major curved section 41 while the second leading ends 61 of the second windings are spot-soldered on the minor curved sections 42, 43 and 44 without removing the coated portion from the first and second leading ends 51, 61, the entire lengths of the metal wires enclosed in the coated sheaths of the first and second windings are electrically communicated with the major curved section 41 and the minor curved sections 42, 43 and 44.

One specific feature of the present invention resides in that the distal sections of the power conducting wires 70 are spot-soldered on the second leading ends 61 of the second windings, the entire lengths of the power conducting wires 70 are electrically communicated with the minor curved sections 42, 43 and 44 of the copper circuit path 40 via the entire length of the metal wires enclosed within the coated sheath with no coated sheath removal is conducted relative to the second leading ends 61. Hence, human labor and waste and time can be avoided.

Another specific feature of the present invention resides in that implementation of the automatic spot soldering device for spot-soldering of the first and second leading ends of the first and second windings and the distal sections of the power conductive wires relative to the copper circuit path, human labor and waste and time can be avoided.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A stator structure for a motor unit, comprising:
a main body;
an insulated member mounted on the main body;
a plastic body disposed on the insulated member;
a copper circuit path disposed on the plastic body;
a plurality of first windings, each first winding being wound on the main body, consisting of a first metal wire and a first coated sheath enclosing the first metal wire, and including a first leading end extending through the insulated member so as to be soldered on the copper circuit path;
a plurality of second windings, each second winding being wound on the main body, consisting of a second metal wire and a second coated sheath enclosing the second metal wire, and including a second leading end extending through the insulated member so as to be soldered on the copper circuit path; and
a plurality of power conducting wires, each having a distal section soldered with the corresponding second leading end of a respective one of the second windings.

2. The stator structure according to claim 1, wherein the first and second leading ends of the first and second windings are spot-soldered respectively on the copper circuit path while the distal section of a respective one of the power conducting wires is spot-soldered to the second leading end of a respective one of the second windings.

3. The stator structure according to claim 2, the first and second leading ends of the first and second windings are spot-soldered respectively on the copper circuit path by means of a spot soldering device while the distal section of a respective one of the power conducting wires is spot-soldered the second leading end of a respective one of the second windings by means of the spot soldering device.

4. The stator structure according to claim 1, wherein the plastic member is ring-shaped, and defines an annular recess in order to receive the copper circuit path therein, the first and second leading ends of the first and second windings extending into the annular recess for soldering with the copper circuit path.

5. The stator structure according to claim 4, wherein the plastic member has an annular peripheral portion formed with a plurality of first notches in spatial communication with the annular recess, the first and second leading ends of the first and second windings passing through the first notches for access into the annular recess so as to be soldered with the copper circuit path.

6. The stator structure according to claim 5, wherein the annular recess is accessible from an upper side of the plastic member.

7. The stator structure according to claim 1, comprising three first windings, three second windings and three power conducting wires, the copper circuit path consisting of a major curved section and three minor curved sections, each having a curved length shorter than that of the major curved section, the first leading ends of the three first windings being soldered on the major curved section while the second leading ends of the three second windings being soldered on the three minor curved sections respectively, three distal sections of the three power conducting wires being soldered respectively on the second leading ends of the three second windings while the other three distal sections of the three power conducting wires being coupled electrically with a three-phase A/C electric power.

8. The stator structure according to claim 7, wherein the major curved section and three minor curved sections of the copper circuit path are formed by punching in such a manner that the major curved section and one minor curved section adjacent to the major curved section cooperatively define a gap therebetween and an adjacent pair of the minor curved sections define another gap therebetween.

9. The stator structure according to claim 8, wherein the plastic member is ring-shaped, and has an annular peripheral portion formed with four second notches, each is aligned with a respective one of the gaps formed between the major curved section and adjacent one minor curved section and the adjacent pair of the minor curved sections.

10. The stator structure according to claim 8, wherein the plastic member further defines positioning holes located exterior of the annular peripheral portion and respectively aligned with corresponding ones of the gaps formed between the major curved section and adjacent one minor curved section and the adjacent pair of the minor curved sections.
